(19) United States
(12) Patent Application Publication
(10) Pub. No.: US 2008/0162673 A1
(43) Pub. Date: Jul. 3, 2008

(54) Method and apparatus to manage sensors

(76) Inventors: Mansoor Ahamed Basheer Ahamed, Bangalore (IN); Rajeev Tiwari, Bangalore (IN); Padmashree K. Apparao, Portland, OR (US)

Correspondence Address: INTEL/BLAKELY, 1279 OAKMEAD PARKWAY, SUNNYVALE, CA, 94085-4040, US

(21) Appl. No.: 11/648,489

(22) Filed: Dec. 28, 2006

(51) Int. Cl. G06F 15/177

(52) U.S. Cl. 709/220

(57) ABSTRACT

A method and an apparatus to manage sensors on an autonomous computing network, platform and similar other systems are illustrated. The sensor management module may comprise a sensor management server, a sensor management client and a sensor driver. The sensor management module may discover presence or absence of the sensor on the computing environment and register it with the server management stack automatically.

### BACKGROUND

In a variety of systems, such as, a computer system, an autonomous computing network, a platform and similar other systems, sensors may be used to monitor hardware errors and to retrieve operating system (OS) instrumentation data. The system may include, server management stacks, to manage the sensor available in the system. The server management stacks typically include hard coding to control the availability of the sensors while other management stacks provide an application to configure the availability of the sensors in the system manually. However, the system itself may not be capable of discovering the presence or the absence of the sensor.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a sensor management module in a computing environment.

FIG. 2 illustrates another embodiment of the sensor management module in the computing environment.

FIG. 3 illustrates an embodiment of a sensor management module in a platform.

FIG. 4 illustrates detailed view of an embodiment of a sensor management server and

FIG. 5 illustrates an embodiment of a process of sensor management that may be implemented by the sensor management module of FIG. 1, FIG. 2, and FIG. 3.

### DETAILED DESCRIPTION

In the following detailed description, numerous specific details are described in order to provide a thorough understanding of the invention. However the present invention may be practiced without these specific details. In other instances, well known methods, procedures, components and circuits have not been described in detail so as not to obscure the present invention. Further, exemplary sizes, values and ranges may be given, but it should not be understood that the present invention is limited to these specific example.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, elements referred to herein with a common reference label followed by a particular letter may be collectively referred to by the reference label alone. For example, sensors 110-A, 110-B to 110-N may be collectively referred to as sensors 110.

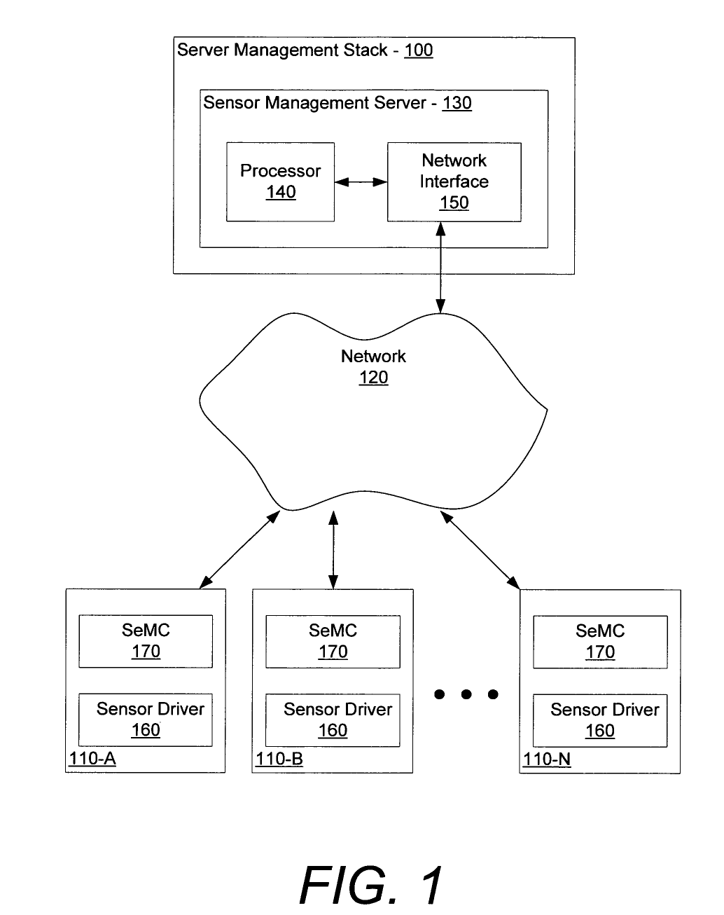

Referring to FIG. 1, an embodiment of a sensor management module (SeMM) in a computing environment is illustrated. The computing environment may comprise a server management stack 100, sensors 110-A, 110-B to 110-N coupled to the server management stack 100 through a network 120. The server management stack 100 may comprise a sensor management server (SeMS) 130 to discover and manage the sensors 110 present in the computing environment. The sensors 110 may comprise application compatible sensors 110 to interact with the SeMS 130. The network 120 may comprise a wired network. In one embodiment, the network 120 may comprise a wireless network 120. The SeMS 130 may act as an interface between the server management stack 100 and the sensors 110 to query for sensors 110. Example of queries may include requesting availability of the sensors 110 on the computer environment, reading sensor data, and setting sensor thresholds.

As depicted, the SeMS 130 may comprise a processor 140 and a network interface 150. The SeMS 130 may be coupled to a sensor management client (SeMC) 170 through a network 120. The processor 140 may process a request received from the SeMC 170 to register or unregister a sensor with the SeMS 130. In one embodiment, the SeMC 170 may be included with each of the sensors 110 and may be coupled to the SeMS 130 through the network interface 150. In one embodiment, a sensor driver 160 may be provided with each of the sensors 110 to make the sensors 110 compatible with the SeMC 170.

In one embodiment, the SeMS 130 may be implemented on a server management stack 100. The SeMS 130 may generate and broadcast a message to inform the SeMC 170 of the presence of the SeMS 130 in the computing environment. The message may be broadcasted to the computing environment during initialization of the server management stack 100 to inform the SeMC 170 regarding the presence of the SeMS 130. In one embodiment, the message may be broadcasted periodically subsequent to the initialization of the server management stack 100. The message may comprise an internet protocol (IP) address for the SeMS 130. In one embodiment, the message may include additional useful information, such as, the capacity and the capability of the SeMS 130. The message may be a user datagram protocol (UDP) or a transmission control protocol (TCP) based on the reliability requirements.

The sensor management server (SeMS) 130, according to an embodiment, may manage an inventory of all the sensors 110 available in the computing environment. The SeMS 130 may add the sensors 110 to the computing environment in response to receiving a request from the sensor management client (SeMC) 170. In one embodiment, the SeMS 130 may remove the sensor 110 in response to receiving a request from the sensor management client 170. The SeMC 170 may act as an interface between the SeMS 130 and the sensor driver 160 to query for sensor 110. Example of query may include requesting availability of the sensor 110 in the computing environment, reading sensor data and setting sensor thresholds. In one embodiment, the SeMS 170 may send a request for information to the sensor 110.

In one embodiment, the sensor management client (SeMC) 170 may comprise a client application, which may respond to the queries generated by the SeMS 130. The SeMC 170, in one embodiment, may generate and broadcast a message to identify the presence of the SeMS 130 in the computing environment. The SeMC 170, in one embodiment, may communicate with the sensor driver 160. In one embodiment, the SeMC 170 and the sensor driver 160 may both be provided in a module of sensors 110.

In one embodiment, the sensor driver 160 may be implemented on the hardware components of each of the sensors 110. The sensor driver 160 may interact with the hardware components of the sensors 100 and may interact with operating system (OS) drivers to read or write OS instrumentation data. In one embodiment, the sensor driver 160 of the newly added sensor 110N may be loaded and may register itself with the SeMC 170. In one embodiment, SeMC 170 may broadcast a message to determine the presence of the SeMS 130 on the computing environment and may receive an acknowledgement from the SeMS 130. The SeMC 170 may then request the SeMS 130 to register the newly added sensor 110-N. According to an embodiment, registration of the new sensor 110-N may include storing information, for example, the capabilities, class, type and other similar useful information of the newly added sensor 110-N, with the SeMM sever 130.

In one embodiment, the SeMC 170 may, upon removal of a sensor 110 from the computing environment, request the SeMS 130 to unregister the sensor 110. The SeMS 130 may, upon receiving such removal request form the SeMC 170, determine which of the sensors 110 has been removed and unregister the sensor 110.

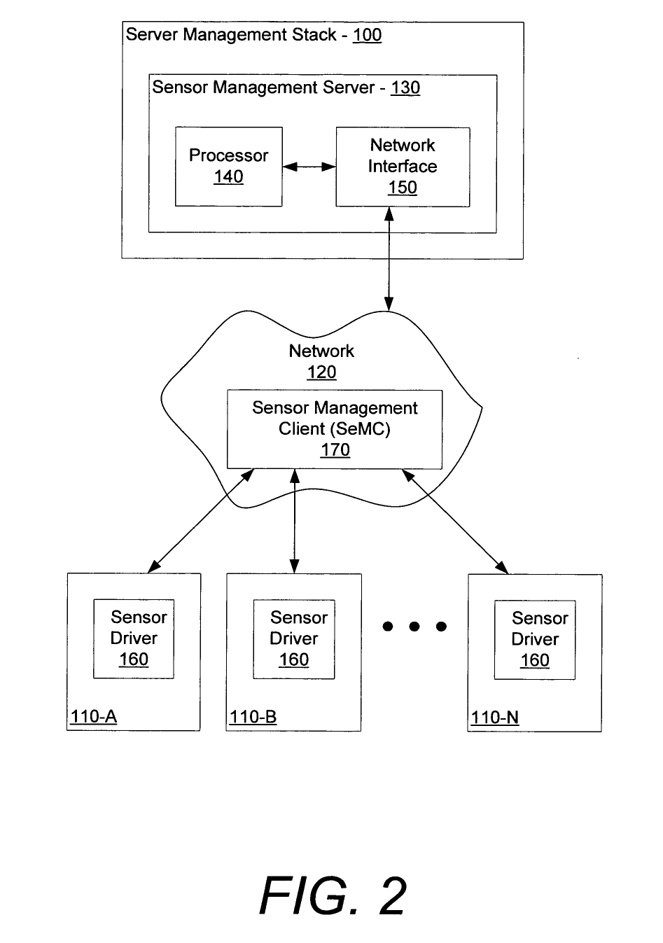

Referring now to FIG. 2, another embodiment of a sensor management module (SeMM) in a computing environment is illustrated. The computing environment may comprise a server management stack 100, sensors 110 coupled to the server management stack 100 through a network 120. The server management stack 100 may comprise a sensor management server (SeMS) 130. The sensors 110 may comprise application compatible sensors 110 to interact with the SeMC 170. In one embodiment and as depicted, a SeMC 170 may be provided with the network 120. The SeMC 170 may receive signals from a sensor driver 160. In one embodiment, the sensor driver 160 may be provided with each of the sensors 110 to make the sensors 110 compatible with the SeMS 130. In one embodiment, the sensor 160 may interact with the SeMC 170 to inform the SeMC 170 of the presence of the sensors 110.

In one embodiment, the SeMS 130 may generate and broadcast a message to inform the computing environment of the presence of the SeMS 130. The message, in one embodiment, may be broadcasted to the SeMC 170 during initialization of the server management stack 100 and subsequently the message may be broadcasted periodically. In one embodiment, the message may comprise an internet protocol (IP) address to enable the SeMC 170 to identify the SeMS 130.

The SeMS 130, according to an embodiment, may manage an inventory of all the sensors 110 available in the computing environment. The SeMS 130 may add the sensors 110 to the computing environment in response to receiving a request from the SeMC 170. In one embodiment, the SeMS 130 may remove the sensor 110 in response to receiving a request from the sensor management client 170. The SeMC 170 may act as an interface between the SeMS 130 and the sensors 110 to query for sensors 110. Example of query may include requesting availability of the sensor 110 in the computing environment, reading sensor data and setting sensor thresholds.

In one embodiment, the sensor 110 may comprise hardware components having a sensor driver 160 implanted on the hardware components of the sensors 110. In one embodiment, the sensor driver 160 may comprise a software or a firmware. The sensor drivers 160 may read data from the hardware sensor and may interact with operating system (OS) drivers to read and write OS instrumentation data. In one embodiment, the sensor driver 160 for the new sensor 110-N may be loaded and registered with the SeMS 130. The sensor driver 160 may provide information, such as, the capabilities of the sensor, class and type of the new sensor 110-N to the SeMS 130. In response to removing a sensor 110 from the computing environment, the SeMS 130 may identify which sensor 110 has been removed and may update, for example, a sensor device list, of the SeMS 130 of removal of the sensor 110.

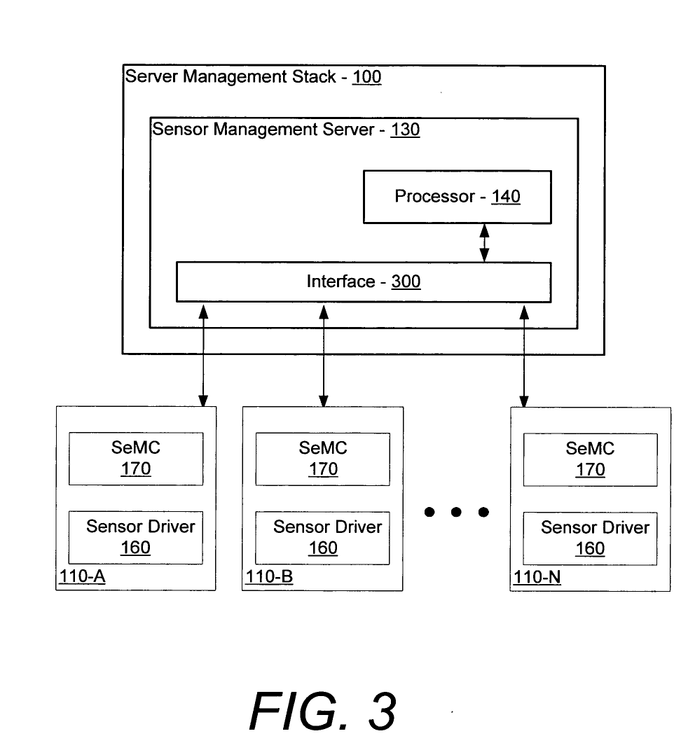

Reference is now made to FIG. 3, an embodiment of a sensor management module (SeMM) in a platform environment is illustrated. As depicted, the platform environment may comprise a sensor management stack 100, a SeMS 130 provided with the sensor management stack 100. The SeMS 130 may be coupled with the sensors 100. The SeMS 130 may comprise a processor 140 and an interface 300 to couple the SeMS 130 to the sensors 110. A SeMC 170 may be provided with each of the sensors 110 having a sensor driver 160 provided therewith. The SeMC 170 may communicate with the SeMS 130 using a proprietary protocol. In one embodiment, the SeMC 170 may be provided with the SeMS 130 and may communicate with the sensor driver 160 of the sensors 110.

The SeMS 130 may manage an inventory of the sensors 110 available on the platform environment. The SeMS 130 may act as an interface between the management stack 100 and the sensors 110 to handle queries for the available sensors 110. In one embodiment, the SeMS 130 may add new sensor 110-N to a sensor device list of the SeMS 130, in response to receiving a request of adding a new sensor 110-N to the computing environment. The SeMS 130 may remove a sensor 110 from the sensor device list, in response to receiving a request regarding removal of an available sensor 110 from the computing environment.

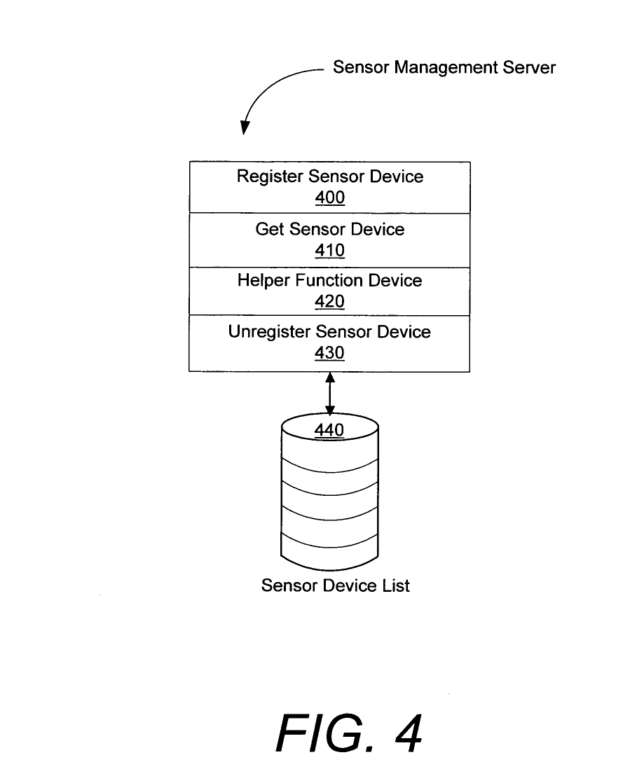

Reference is now made to FIG. 4, detailed view of an embodiment of a sensor management server (SeMS) is illustrated. As depicted, the SeMS 130 may comprise a register sensor device 400, a get sensor device 410, a helper function device 420, an unregister sensor device 430, and a sensor device list 440.

The register sensor device 400 may receive a request from the SeMC 170 or the sensor driver 160, of the presence of a new sensor 110-N on the computing environment or platform. The get sensor device 410 may get the details such as capability of the newly added sensor 110-N, type of the sensor 110-N and other similar useful information of the sensor 110-N and store the information. The register sensor device 400 may inform the sensor device list 440 thorough the helper function device 420 to add the presence of the new sensor 110-N in the computing environment. In one embodiment, the helper function device 420 may be used to retrieve the information of the available sensor 110 and the properties of the available sensor 110 in the computing environment. In one embodiment, the unregister sensor device 430 may receive a request from the SeMC 170 or a sensor driver 160, of the removal of a sensor 110 from the computing environment. The unregister sensor device 430 may inform the sensor device list 440 to remove the sensor from the computing environment and update the sensor device list 440 based on the available sensor 110 on the computing environment.

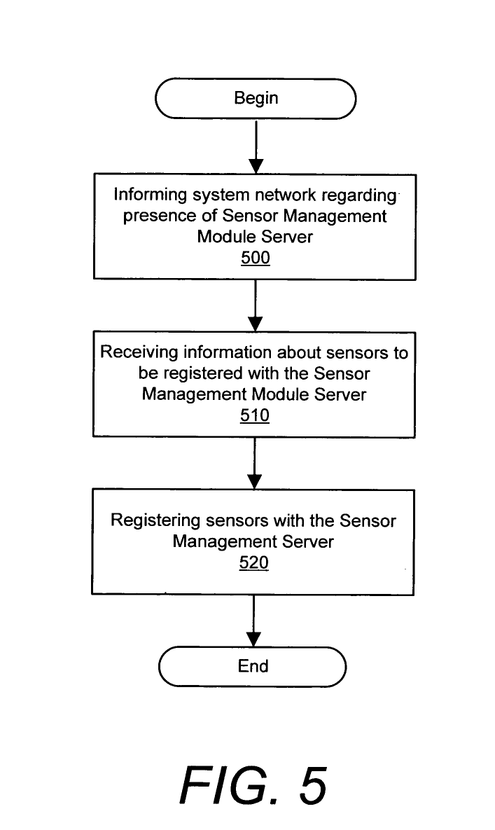

Reference is now made to FIG. 5 an embodiment of a process of the sensor management server (SeMS) is illustrated. In block 500, the sensor management SeMS may generate and broadcast a message, during initialization of the sensor management stack and subsequently, periodically, to inform the computing environment of the presence of SeMS in the computing environment. The massage, according to an embodiment, may have an IP address to identify location of the SeMS in the computer environment or the platform. The massage may be a user datagram protocol (UDP). In one embodiment the message may be a transmission control protocol (TCP) based on the reliability requirements.

In block 510, the SeMS may receive information of the sensor from the sensor management client (SeMC) or sensor drivers. In one embodiment, the SeMC may communicate with the sensor driver to retrieve the information regarding the sensor. The SeMC, in response to receiving the message from the SeMS, may communicate with the SeMS and may requests the SeMS to register or unregister the sensor along with the information of the sensor.

In block 520, the SeMS may, upon receiving a request from the SeMC or sensor driver, register the available sensor and add the sensor to the sensor device list of the SeMS. In one embodiment, the SeMS may add the sensor to the sensor device list or remove the sensor from the sensor device list, based on the request received from the SeMC or sensor drivers. The SeMS, according to an embodiment, may manage an inventory of all the sensors available in the computing environment. The SeMS may register a new sensor and add the sensor to the sensor device list upon adding a new sensor to the computing environment. The SeMS may unregister the available sensor and remove it from the sensor device list upon removing the available sensor from the computing environment. The SeMS may act as an interface between the management stack and the sensors to query for the sensors in the computer environment.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method to manage sensors comprising:
generating and broadcasting a message, wherein the message is to inform of a presence of a sensor management server;
detecting a presence of a sensor;
sending a request for information to the sensor; and
registering the sensor with the sensor management server based on the information.

2. The method of claim 1, wherein the message is broadcast to a computing environment by the sensor management server.

3. The method of claim 2, further comprising generating and broadcasting the message to a platform by the sensor management server.

4. The method of claim 3, wherein the message includes an internet protocol (IP) address, wherein the IP address is to identify the sensor management server.

5. The method of claim 1, further comprising generating and broadcasting a message by a sensor management client to identify the sensor management server.

6. The method of claim 1, wherein the request is from a sensor management client for adding a new sensor.

7. The method of claim 1 wherein the request is from the sensor management client for removing an available sensor.

8. The method of claim 1 wherein registering comprises adding a new sensor to a sensor device list of the sensor management server based on the information.

9. The method of claim 1 further comprising unregistering an available sensor and removing the sensor from the sensor device list of the sensor management server based on the information.

10. A sensor management module comprising:
a sensor management server to add and remove a sensor to and from a sensor device list of the sensor management server; and
a sensor management client to couple between the sensor management server and a sensor.

11. The sensor management module of claim 10, wherein the sensor management server generates a message with an IP address and broadcasts the massage to the computing environment to inform its presence.

12. The sensor management module of claim 10, wherein the sensor management server receives a request from a sensor management client to add the sensor and adds the sensor to a sensor device list, based information received from the sensor management client.

13. The sensor management module of claim 10, wherein the sensor management server receives a request to remove the sensor and removes the sensor from sensor device list, based on information received from the sensor management client.

14. The sensor management module of claim 10, wherein the sensor management client generates and broadcasts a message to identify presence of the sensor management server.

15. The sensor management module of claim 14, wherein the sensor management client receives information from a sensor driver and requests the sensor management server to add or remove the sensor from a sensor device list of the sensor management server.

16. A machine-readable medium comprising a plurality of instructions that, in response to being executed, results in a sensor management module comprising:
generating and broadcasting a message to inform of a presence of a sensor management server;
detecting a presence of a sensor; and
registering the sensor with the sensor management server based on the information.

17. The machine-readable medium of claim 16, wherein the plurality of instructions further result in the sensor management module to receive a request to add a sensor and adds the sensor to a sensor device list.

18. The machine-readable medium of claim 17, wherein the plurality of instructions further result in the sensor management module receiving a request to remove a sensor and removing the sensor from the sensor device list.
